(19) United States
(12) Patent Application Publication
(10) Pub. No.: US 2026/0170156 A1
(43) Pub. Date: Jun. 18, 2026

(54) SYSTEM AND METHOD FOR DELIVERING SECURITY-AS-A-SERVICE SOLUTIONS IN REGULATED COUNTRIES

(71) Applicant: Lookout Inc., Boston, MA (US)

(72) Inventor: Meenakshi Sundaram Lakshmanan, San Jose, CA (US)

(21) Appl. No.: 18/982,693

(22) Filed: Dec. 16, 2024

(51) Int. Cl. G06F 21/60

(52) U.S. Cl. CPC G06F 21/606

(57) ABSTRACT

Traffic from a remote endpoint of an enterprise is processed by a cloud-based module performing a security service, such as SWG, ZTNA, or CASB. The traffic is forwarded back to a server of the enterprise for transmission over a leased line to a destination endpoint. The remote endpoint, cloud-based module, and server may be in a first jurisdiction and the destination endpoint may be in a second jurisdiction such that cross-border controls are performed more efficiently by a provider of the leased line.

### BACKGROUND

In many jurisdictions, data transmissions are highly regulated and subject to scrutiny by a government authority. In such jurisdictions, implementing cloud-based solutions may be delayed by such scrutiny.

### BRIEF DESCRIPTION OF THE FIGURES

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment for processing network traffic in accordance with an embodiment of the present invention;

FIGS. 2A to 2C are process flow diagrams of methods for routing network traffic in accordance with an embodiment of the present invention;

FIG. 3 illustrates a process for performing routing of traffic using a customer connector in accordance with an embodiment of the present invention; and

FIG. 4 is a schematic block diagram of a computer system suitable for implementing methods in accordance with embodiments of the present invention.

### DETAILED DESCRIPTION

It will be readily understood that the components of the invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the invention may be embodied as an apparatus, method, or computer program product. Accordingly, the invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the invention may be written in any combination of one or more programming languages, including an object-oriented programming language such as Java, Objective-C, Swift, C++, or the like and conventional procedural programming languages, such as the “C” programming language or similar programming languages, and may also use descriptive or markup languages such as HTML, XML, JSON, and the like. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

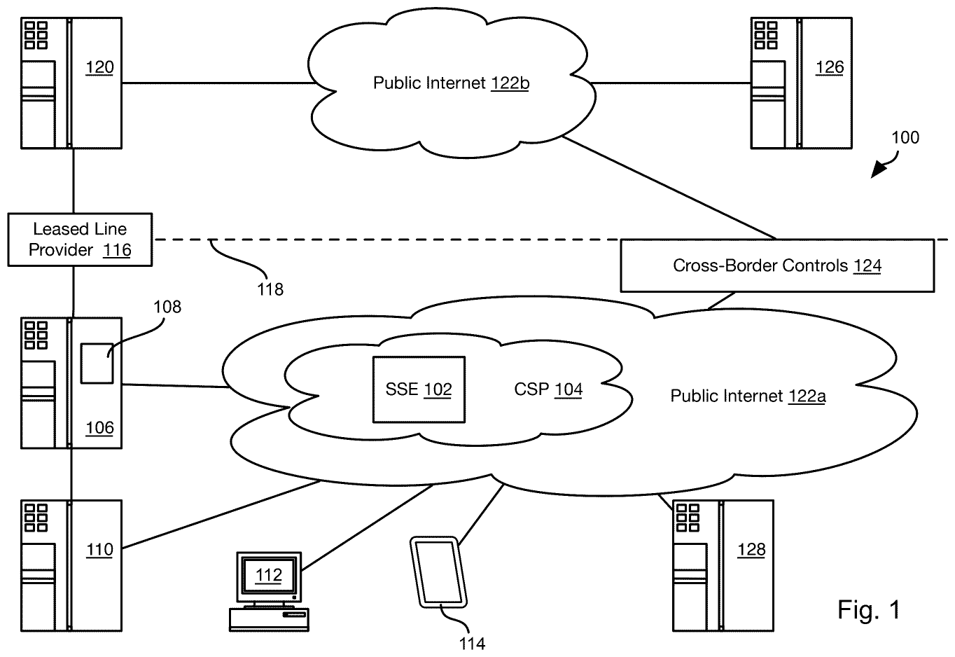

Referring to FIG. 1, governments across the world are increasingly regulating internet access for businesses for security and political reasons. An example of this is the Great Firewall of China (GFC), a regulatory body that monitors and controls Internet access by anyone within China. Various technical methods are employed by the Chinese government, including internet protocol (IP) blocking, which involves denying access to specific domains by blocking their IP addresses, packet filtering that scans data packets for contentious keywords, credit record scrutiny, and speech and facial recognition.

Enterprise organizations in China do have general Internet connection. However, Internet traffic has to go through the GFC if there is communication outside of China, which causes increased latency and other inefficiencies. Organizations will often avoid the GFC by routing traffic over a leased line that bypasses the GFC. Traffic over the leased line will have to pass through dedicated leased line solutions provided by any of three telecom companies in China: China Telecom, China Unicom and China Mobile. Although their service relies on standard internet protocols, they have received approval from the Ministry of Industry and Information Technology (MIIT) in China to offer this service because they commit to directing all outgoing traffic through the Great Firewall of China. Enterprises in China will often have agreements with the leased line providers not to send/forward any unauthorized traffic. Traffic over the leased line still goes through some inspection, which is more efficient than the Great firewall of China. The enterprise organizations in China bring all the traffic to a data center and then it can be forwarded to these leased lines. These enterprises examine the outgoing data for data exfiltration, threat prevention etc. The enterprises also go through leased lines to access online applications like GOOGLE or any cloud-based application.

However, on-premise security solutions are not enough when accessing online applications. Enterprises in China have started looking into cloud-delivered security solutions like secure service edge (SSE). In cloud-delivered security solutions, all the traffic from enterprise customers goes through SSE rather than through the customer's data center. It helps customers improve operational efficiency, otherwise they will have to manage traditional security which is less efficient and more expensive. Through these cloud-delivered solutions, things like zero trust network access (ZTNA), data-theft prevention, threat prevention, and other security capabilities are all enforced at the SSE. Some traffic processed by the SSE may be addressed to entities outside of China. However, such traffic may be blocked or at least delayed by the GFC.

FIG. 1 illustrates a network architecture 100 that enables cloud-delivered solutions, particularly security solutions, to be delivered in compliance with government regulations, such as MIIT regulations, while reducing inefficiencies.

In the illustrated network architecture 100 includes an SSE 102. The SSE 102 may be a cloud-based module that executes in a cloud service provider (CSP) 104. The SSE may also execute on a discrete server system or other hardware configuration and still perform the functions described herein. Although a single SSE 102 is shown, there may be multiple SSEs 102, such as one in each regional cloud of a plurality of regional clouds of a CSP 104 or of multiple CSPs 104.

Security services implemented by the SSE 102 may include operating as a software gateway (SWG), functioning as a cloud access security broker (CASB), and providing zero trust network access (ZTNA). The SSE 102 may function as a firewall, provide malware detection, or perform any other security service known in the art. Although the SSE 102 is described in detail herein, any other cloud-based module may benefit from the approach described herein.

The SSE 102 may be connected to various endpoints of an enterprise. For example, a server system 106 of an enterprise. As used herein “a server system 106” may be a single server, a plurality of networked servers, a data center, or other computing facility. The server system 106 may execute a customer connector 108. The customer connector 108 may be an agent of the SSE 102 and cooperate with the SSE 102 to route traffic as described in detail below. There may be any number of instances of customer connectors 108 in the server system 106.

Other endpoints may include one or more additional server systems 110 that may be associated with a branch office, affiliate, or other unit of an enterprise. The endpoints of an enterprise may include a user endpoint 112, such as a laptop or desktop computer, tablet computer, or other computing device may be used by a representative of the enterprise, such as a remote worker. The endpoints of an enterprise may include a user endpoint 114, such as a mobile device may likewise be used by a representative of the enterprise.

The endpoints 112, 114 may be managed devices in the sense that the endpoints 112, 114 execute software configured to interface with the SSE 102 to implement security services of the SSE 102, such as interfacing with the SSE 102 as a software gateway (SWG), cloud access security broker (CASB), or provider of zero trust network access (ZTNA). The endpoints 112, 114 may perform other functions to prevent unauthorized access or transmission of enterprise data. For example, the endpoints 112, 114 may execute mobile device management (MDM) software according to any approach known in the art.

The server system 106 may connect to a leased line provided by a leased line provider 116. The leased line provider 116 may provide for the transfer of data across a border 118, such as from a highly regulated jurisdiction including the endpoints 106, 110, 112, 114 (hereinafter “the first jurisdiction”) to another jurisdiction that may not be as regulated or be subject to different regulations (hereinafter “the second jurisdiction”). The second jurisdiction may include another enterprise server system 120 that is connected to a leased line provided by the leased line provider 116.

The first jurisdiction may include a public internet 122a, e.g., a portion of the Internet that is within the first jurisdiction or controlled by the first jurisdiction. Stated differently, the public internet 122a may be a portion of the Internet such that traffic within the public internet 122a is not subject to regulation by a cross-border controls 124 of the first jurisdiction, e.g., by the GFC where the first jurisdiction is China. The endpoints 106, 112, 114, 110 may connect to the SSE 102 by way of the public internet 122a or direct connections to the CSP 104, such as to a point of presence (POP) of the CSP 104.

The second jurisdiction may include a public internet 122b, e.g., the portion of the Internet that is not in the first jurisdiction such that data passing to and/or from the public internet 122b from the public internet 122a is subject to scrutiny by the cross-border controls 124. The server system 120 may be connected to the public internet 122b.

Endpoints 110, 112, 114 may connect to the server system 106 by way of the public internet 122a. In such scenarios, endpoints 106, 110, 112, 114 of an enterprise may connect to the SSE 102 by way of tunnels, such as virtual private network (VPN) tunnels, Internet Protocol Security (IPsec) tunnels, software defined wide area network (SD-WAN) tunnel, or the like. The tunnels may be associated at the SSE 102 with the enterprise such that traffic received over the tunnels may be associated with the enterprise and routed according to policies of the enterprise as discussed in greater detail below.

Endpoints 110, 112, 114 may additionally or alternatively connect to the SSE 102 by way of the server system 106 or other server operated on behalf of the enterprise. Such endpoints 110, 112, 114, may be connected to a local area network (LAN) and/or VPN of the enterprise. The endpoints 110, 112, 114 may therefore connect to the SSE 102 by way of the tunnel connecting the server system 106 to the SSE 102.

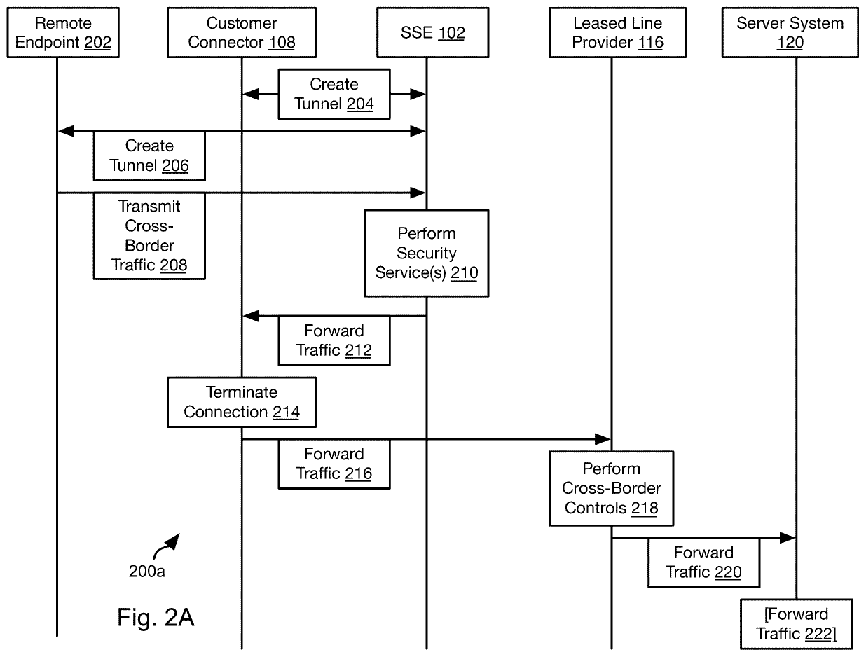

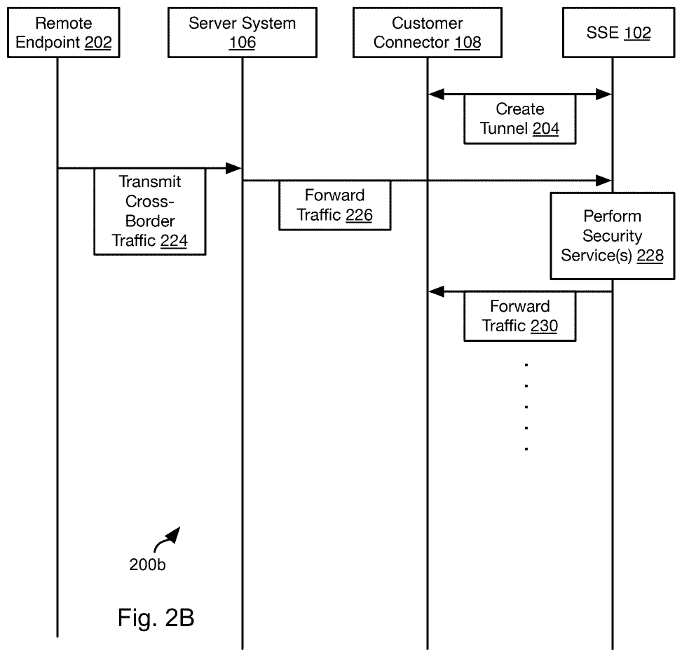

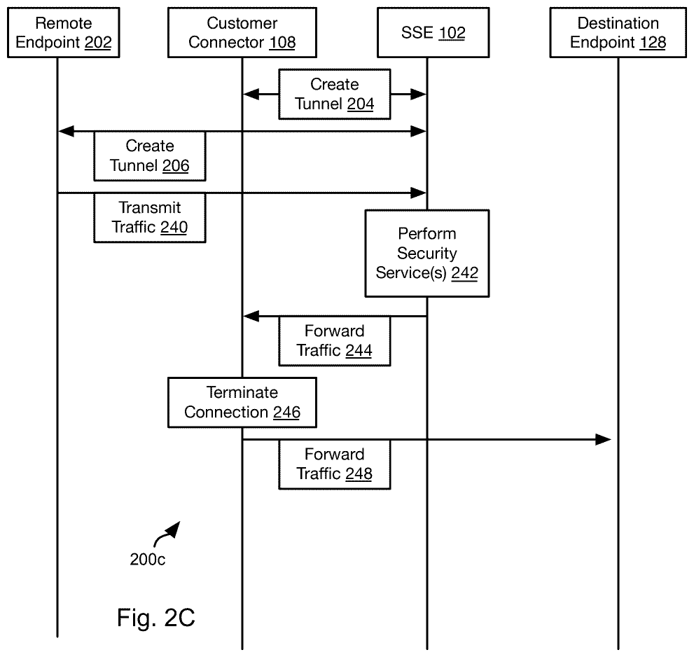

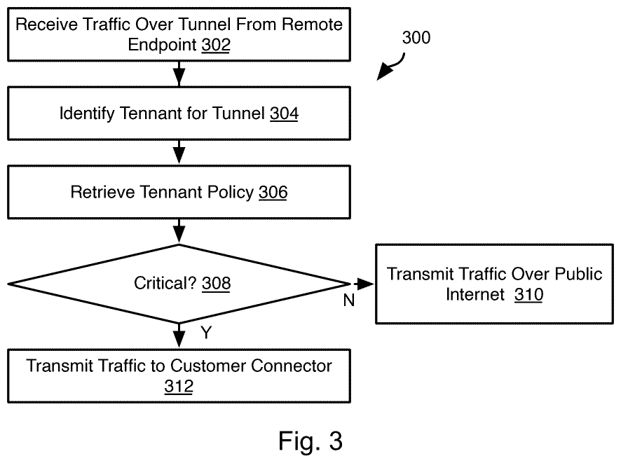

In some of the examples disclosed herein, a destination endpoint 126 for traffic from a representative of the enterprise (e.g., from endpoints 112, 114) is in the second jurisdiction. The destination endpoint 126 may be connected to the public internet 122b. The server system 120 of the enterprise may be in data communication with the destination endpoint 126 by way of the public internet 122b or other type of network connection. The destination endpoint 126 may be a service such any online service or application, such as GOOGLE. In another example, endpoints 112, 114 execute clients (e.g., web browsers) interfacing with software as a service (SaaS) applications in the second jurisdiction. Traffic directed to destination endpoints 126 in the second jurisdiction may be processed using the approach described below with respect to FIGS. 2A, 2B, and FIG. 3.

For destination endpoints 128 within the first jurisdiction, traffic from the endpoints 106, 110, 112, 114 may be transmitted by the SSE 102 to the destination endpoint 128, such as over the CSP 104 and/or the public internet 122a. In particular, the traffic may be sent by the SSE 102 to the destination endpoint 128 in bypass of the server system 106 and the customer connector 108.

Referring to FIG. 2A, the network architecture 100 may execute the illustrated method 200a. The method 200a uses the backbone of the CSP 104 to deliver secure internet access, secure private access, and secure cloud access that can help enterprises around the world transmit data to and from the first jurisdiction in an efficient, productive way.

The method 200a may be performed with respect to a remote endpoint 202 that may be any of the endpoints 106, 110, 112, 114 connecting to the SSE 102 in any of the ways illustrated in FIG. 1. The method 200a is particularly useful for managed or non-managed endpoints 112, 114 that connect to the SSE 102 by way of the public internet 122a.

The method 200a may include creating 204 a tunnel between the SSE 102 and the customer connector 108 on the server system 106. The tunnel may be associated with an account of the enterprise on whose behalf the server system 106 is operated. For example, the customer connector 108 may login or otherwise authenticate with respect to an account of the enterprise managed by the SSE 102 before, after, or as part of creating 204 the tunnel.

The method 200a may include creating 206 a tunnel between the remote endpoint 202 and the SSE 102. The tunnel may be associated with an account of the same enterprise as the server system 106, e.g., the enterprise that manages the MDM of the remote endpoint 202. For example, the remote endpoint 202 (perhaps the MDM of the remote endpoint 202) may login or otherwise authenticate with respect to an account of the enterprise managed by the SSE 102 before, after, or as part of creating 206 the tunnel.

The method 200a may include the remote endpoint 202 transmitting 208 cross border traffic to the SSE 102 over the tunnel from step 206, such as traffic to be processed by a software gateway (SWG), a cloud access security broker (CASB), or as part of zero trust network access (ZTNA). The cross-border traffic may be addressed to a destination endpoint 126 in the second jurisdiction.

The SSE 102 may perform 210 a security service (SWG, CASB, ZTNA) with respect to the traffic. The SSE 102 may make a decision regarding routing the traffic following step 210. Example logic for making the decision is described below with respect to FIG. 3. In the illustrated example, the traffic is cross-border traffic from the first jurisdiction to the second jurisdiction and the decision is to forward 212 the traffic to the customer connector 108 and to the leased line provider 116.

The customer connector 108 may terminate 214 connections for the traffic, e.g., be an endpoint of tunnels, acknowledge transmission (e.g., per Transmission Control Protocol), perform handshaking to establish connections, or the like. The customer connector 108 may then forward 216 the traffic to the leased line provider 116. The leased line provider 116 may perform 218 cross border controls required by the first jurisdiction with respect to the traffic. If the traffic is approved according to the cross-border controls, the leased line provider forwards 220 the traffic to the destination endpoint of the traffic. For example, the traffic may be forwarded 220 by the leased line provider 116 to an enterprise server system 120, such as over a leased line connecting the server system 120 to the leased line provider 116. The server system 120 may then forward 222 the traffic to the destination endpoint 126, such as over the public internet 122b.

Using the construct implemented by the method 200a, referred to herein as “reverse hairpinning,” enables the benefit of a cloud-based SSE 102 as well as the lower latency of a leased line provider 116, as compared to cross-border controls 124 implemented for public internet traffic.

Note that the return path of a response from the destination endpoint 126 may be the reverse of the flow of traffic from the remote endpoint 202: over the public internet 122b to the server system 120, through the leased line provider 116, to the customer connector 108, to the SSE 102 over the tunnel from step 204, and from the SSE 102 to the remote endpoint 202 over the tunnel from step 206. Network address translation (NAT) and other routing protocols may be used to route the traffic to the remote endpoint 202.

FIG. 2B illustrates an alternative method 200b for performing reverse hairpinning. In the method 200 b a tunnel is created 204 between the customer connector 108 and the SSE 102 as described above. Traffic from a remote endpoint 202 is transmitted 224 to the server system 106 and forwarded 226 by the server system 106 to the SSE 102 through the tunnel from step 204. The SSE performs 228 security services as described above and forwards 230 the traffic following processing to the customer connector 108 on the same server system 106. The traffic may then be processed as described above with respect to steps 216, 218, 220, 222 of the method 200a. The return path of a response from the destination endpoint 126 may be the reverse of the flow of traffic from the remote endpoint 202.

Referring to FIG. 2C, the illustrated method 200c illustrates how reverse hairpinning may be used for purposes other than transmitting cross-border traffic. For example, the method 200c may be used to transmit traffic to a destination endpoint 128 while having a source of the traffic appear to be in a different location from the remote endpoint 202 that is a source of the traffic. For example, the customer connector 108 may be located in a country or region of a country that is different from a location of the remote endpoint 202. The customer connector 108 may transmit traffic with a source address corresponding to that country or region of a country. In this manner, behavior of the destination endpoint 128, e.g., language and/or other attributes, may be influenced as desired by an operator of the remote endpoint 202. For example, a representative of an enterprise that is traveling in a foreign country may wish to interact with the destination endpoint 128 in the representative's native language.

The method 200 a may include creating 204, 206 tunnels between the SSE 102 and the customer connector 108 and remote endpoint 202, respectively, as described above. The remote endpoint may transmit 240 traffic to the SSE 102, which performs 242 one or more security services with respect to the traffic as described above. The SSE 102 forwards 244 the traffic following step 242 to the customer connector 108, e.g., a customer connector 108 executing at a desired location. The customer connector 108 may terminate 246 a connection to the SSE 102 (see step description of step 214, above) and forward 248 the traffic to the destination endpoint to which the traffic is addressed, such as over one or both of the CSP 104 and the public internet 122a. The return path of a response from the destination endpoint 128 may be the reverse of the flow of traffic from the remote endpoint 202.

FIG. 3 illustrates a method 300 that may be implemented by the SSE 102 and the customer connector 108. The method 300 may be preceded by creating of tunnels between the customer connector 108 and the SSE 102 and between the SSE 102 and a remote endpoint 202 as described above.

The SSE 102 receives 302 traffic over the tunnel from the remote endpoint 202 and identifies 304 a tenant corresponding to the tunnel. As described above, the creation of the tunnel may be accompanied by authentication of a remote endpoint 202 with respect to an account such that step 304 includes identifying that account. The method 300 may include retrieving 306 a tenant policy for the tenant identified at step 304.

At step 308, the SSE 102 may evaluate the tenant policy to determine whether the traffic should be transmitted 310 over the public internet 122a or transmitted 312 to a customer connector 108, e.g., a customer connector 108 that is authenticated with the same account as the remote endpoint 202 according to the method 200a or 200b. The tenant policy may be agnostic to attributes of the traffic: all traffic is to be sent to the customer connector 108 following processing by the SSE 102. The tenant policy may be based on attributes of the traffic: all traffic addressed to an IP address outside of the first jurisdiction may be sent to the customer connector 108. The tenant policy may be connection based: a user may request that the SSE 102 send traffic in the context of a connection be sent to the customer connector 108, such as to obtain the benefits of the method 200c. The tenant policy may be based on criticality: traffic that is deemed critical may be transmitted 312 through the leased line provider 116 by way of the customer connector 108 whereas less critical traffic is transmitted 310 over the public internet 122a. Critical traffic may be distinguished based on the source IP address, source user, destination IP address, destination domains, websites, uniform resource locators (URLs) or other attribute, or combination thereof.

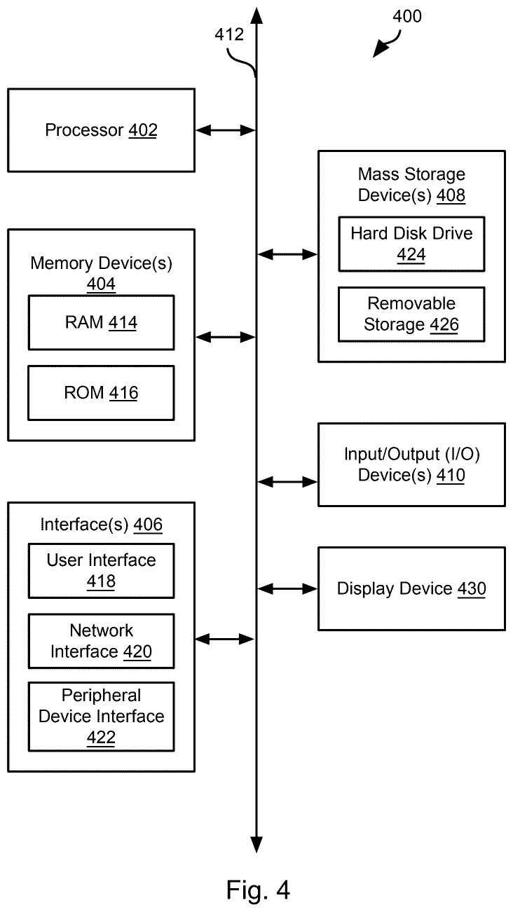

FIG. 4 is a block diagram illustrating an example computing device 400 which can be used to implement the system and methods disclosed herein. In some embodiments, a cluster of computing devices 400 interconnected by a network may be used to implement any one or more components of the invention.

Computing device 400 may be used to perform various procedures, such as those discussed herein. Computing device 400 can function as a server, a client, or any other computing entity. Computing device can perform various monitoring functions as discussed herein, and can execute one or more application programs, such as the application programs described herein. Computing device 400 can be any of a wide variety of computing devices, such as a desktop computer, a notebook computer, a server computer, a handheld computer, tablet computer and the like.

Computing device 400 includes one or more processor(s) 402, one or more memory device(s) 404, one or more interface(s) 406, one or more mass storage device(s) 408, one or more Input/Output (I/O) device(s) 410, and a display device 430 all of which are coupled to a bus 412. Processor(s) 402 include one or more processors or controllers that execute instructions stored in memory device(s) 404 and/or mass storage device(s) 408. Processor(s) 402 may also include various types of computer-readable media, such as cache memory.

Memory device(s) 404 include various computer-readable media, such as volatile memory (e.g., random access memory (RAM) 414) and/or nonvolatile memory (e.g., read-only memory (ROM) 416). Memory device(s) 404 may also include rewritable ROM, such as Flash memory.

Mass storage device(s) 408 include various computer readable media, such as magnetic tapes, magnetic disks, optical disks, solid-state memory (e.g., Flash memory), and so forth. As shown in FIG. 4, a particular mass storage device is a hard disk drive 424. Various drives may also be included in mass storage device(s) 408 to enable reading from and/or writing to the various computer readable media. Mass storage device(s) 408 include removable media 426 and/or non-removable media.

I/O device(s) 410 include various devices that allow data and/or other information to be input to or retrieved from computing device 400. Example I/O device(s) 410 include cursor control devices, keyboards, keypads, microphones, monitors or other display devices, speakers, printers, network interface cards, modems, lenses, CCDs or other image capture devices, and the like.

Display device 430 includes any type of device capable of displaying information to one or more users of computing device 400. Examples of display device 430 include a monitor, display terminal, video projection device, and the like.

Interface(s) 406 include various interfaces that allow computing device 400 to interact with other systems, devices, or computing environments. Example interface(s) 406 include any number of different network interfaces 420, such as interfaces to local area networks (LANs), wide area networks (WANs), wireless networks, and the Internet. Other interface(s) include user interface 418 and peripheral device interface 422. The interface(s) 406 may also include one or more user interface elements 418. The interface(s) 406 may also include one or more peripheral interfaces such as interfaces for printers, pointing devices (mice, track pad, etc.), keyboards, and the like.

Bus 412 allows processor(s) 402, memory device(s) 404, interface(s) 406, mass storage device(s) 408, and I/O device(s) 410 to communicate with one another, as well as other devices or components coupled to bus 412. Bus 412 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 400, and are executed by processor(s) 402. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

1. A method comprising:
transmitting, by a remote endpoint associated with an enterprise, traffic to a cloud-based module configured to perform one or more security services, the traffic being addressed to a destination endpoint that is not part of the enterprise;
receiving, by a server system associated with the enterprise, the traffic from the cloud-based module; and
forwarding, by the server system, the traffic to the destination endpoint.

2. The method of claim 1, wherein transmitting the traffic to the cloud-based module comprises transmitting the traffic over a first tunnel to the cloud-based module, the first tunnel being associated at the cloud-based module with the enterprise.

3. The method of claim 2, wherein receiving the traffic from the cloud-based module comprises receiving the traffic over a second tunnel to the cloud-based module, the second tunnel being associated at the cloud-based module with the enterprise.

4. The method of claim 1, wherein the server system and the remote endpoint are located in a first jurisdiction and the destination endpoint is located in a second jurisdiction that is different from the first jurisdiction.

5. The method of claim 4, further comprising forwarding, by the server system, the traffic into the second jurisdiction over a leased line.

6. The method of claim 4, wherein the cloud-based module is a secure service edge (SSE).

7. The method of claim 1, wherein the cloud-based module implements a software gateway (SWG).

8. The method of claim 1, wherein the cloud-based module implements zero trust network access (ZTNA).

9. The method of claim 1, wherein the cloud-based module implements a cloud access security broker (CASB).

10. The method of claim 1, wherein the traffic is first traffic, the method further comprising:
transmitting, by the remote endpoint, second traffic to the cloud-based module to process according to the one or more security services and forward to the destination endpoint in bypass of the server system.

11. A method comprising:
receiving, by secure service edge (SSE), from a remote endpoint associated with an enterprise, traffic addressed to a destination endpoint that is not part of the enterprise;
performing, by the SSE, a security service with respect to the traffic; and
determining, by the SSE, that the traffic is critical;
in response to determining that the traffic is critical, forwarding, by the SSE, the traffic to a server system associated with the enterprise for forwarding to the destination endpoint over a leased line.

12. The method of claim 11, wherein receiving the traffic from the remote endpoint comprises receiving, by the SSE, the traffic over a first tunnel to the remote endpoint, the first tunnel being associated at the SSE with the enterprise.

13. The method of claim 12, wherein forwarding the traffic to the server system comprises transmitting the traffic over a second tunnel to the server system, the second tunnel being associated at the SSE with the enterprise.

14. The method of claim 11, wherein the server system, remote endpoint, and SSE are located in a first jurisdiction and the destination endpoint is located in a second jurisdiction that is different from the first jurisdiction, the leased line spanning between the first jurisdiction and the second jurisdiction.

15. The method of claim 11, wherein the security service is at least one of a software gateway (SWG), zero trust network access (ZTNA), or a cloud access security broker (CASB).

16. The method of claim 11, wherein the traffic is first traffic, the method further comprising:
receiving, by the SSE, second traffic from the remote endpoint;
performing, by the SSE, the security service with respect to the second traffic;
determining, by the SSE, that the second traffic is not critical; and
in response to determining that the second traffic is not critical, transmitting, by the SSE, the second traffic to the destination endpoint in bypass of the server system.

17. The method of claim 11, wherein determining that the traffic is critical comprises evaluating a destination internet protocol (IP) address of the traffic or destination domain of the traffic.

18. The method of claim 11, wherein determining that the traffic is critical comprises evaluating an attribute of the traffic including at least one of a website or a uniform resource locator (URL).

19. A non-transitory computer-readable medium storing executable code that, when executed by one or more processing devices, causes the one or more processing devices to:
receive, by secure service edge (SSE), from a remote endpoint associated with an enterprise, traffic addressed to a destination endpoint that is not part of the enterprise;
perform, by the SSE, a security service with respect to the traffic, the security service being at least one of a software gateway, zero trust network access, or a cloud access security broker; and
forwarding, by the SSE, the traffic to a server system associated with the enterprise for forwarding to the destination endpoint over a leased line.

20. The non-transitory computer-readable medium of claim 19, wherein the traffic is first traffic, the executable code, when executed by the one or more processing devices, further causing the one or more processing devices to:
receive, by the SSE, second traffic from the remote endpoint;
perform, by the SSE, the security service with respect to the second traffic; and
transmit, by the SSE, the second traffic to the destination endpoint in bypass of the server system.
